(19) United States
(12) Patent Application Publication
(10) Pub. No.: US 2006/0119535 A1
(43) Pub. Date: Jun. 8, 2006

(54) Variable signing system and method thereof

(76) Inventor: Mark Van Fossan, Chatham, NJ (US)

Correspondence Address: CASELLA & HESPOS, 274 MADISON AVENUE, NEW YORK, NY, 10016, US

(21) Appl. No.: 11/044,837

(22) Filed: Jan. 27, 2005

Related U.S. Application Data
(60) Provisional application No. 60/539,906, filed on Jan. 28, 2004.

(51) Int. Cl. G09G 5/00

(52) U.S. Cl. 345/1.1

(57) ABSTRACT

A variable signing system and method thereof are provided. The variable signing system includes a variable sign including a first display for displaying commercial information and a second display for displaying non-commercial information; and at least one server for providing at least the non-commercial information to the variable sign.

This application claims priority to an application entitled “VARIABLE SIGNING SYSTEM AND METHOD THEREOF” filed in the United States Patent and Trademark Office on Jan. 28, 2004 and assigned Ser. No. 60/359,906, the contents of which are hereby incorporated by reference.

### BACKGROUND OF THE INVENTION

1. Field of the Invention

The invention relates generally to advertising and information display systems, and more particularly, to a signing system that includes at least one variable or static display for displaying commercial advertising and a variable display for displaying pertinent non-commercial information. The invention also relates to methods for establishing and controlling such a system.

2. Description of the Related Art

Advertising takes many forms, such as television commercials, newspaper and magazine advertisements, mailings, point-of-sale displays, outdoor billboards, etc.

Focusing on the outdoor advertising component of advertising, it is well known that outdoor billboards traditionally have taken the form of single-message static displays formed of printed sheets or painted surfaces containing the advertising content adhered to a flat backing. This time-honored outdoor advertising technique has remained essentially unchanged throughout the twentieth century. The high cost of printing, transporting and mounting a message on a conventional billboard has dictated that the same message remain in place for a considerable time. Thus, a conventional billboard cannot be changed readily to reflect current events within the geographic area of the billboard.

In another area of information display, the Amber Alert program began in 1996 as a legacy to nine-year old Amber Hagerman, who was kidnapped and brutally murdered while riding her bicycle in Arlington, Tex. Outraged residents contacted radio stations in the Dallas area and suggested broadcasting special “alerts” over the airwaves to help prevent such incidents in the future. As a result, the Dallas/Ft. Worth Association of Radio Managers teamed up with local law enforcement agencies in Northern Texas and developed this innovative early warning system to help find abducted children.

In recent years, the Amber Alert program has gained momentum and has expanded beyond radio broadcasts to include highway electronic message signs, e.g., LED signs, that allow law enforcement agencies to coordinate and broadcast messages to the masses traveling on the nation's roadways. The Amber Alert program has garnered so much national attention and support that the federal government recently unveiled an initiative to broaden it by proposing a national standard for the system and announcing an Amber Alert coordinator at the United States Justice Department. Currently, the federal government has budgeted $10 million for training and equipment upgrades with respect to this program.

Today, in many states across the country, legislators have looked to deploy this innovative technology in the event of an emergency situation. However, government agencies have fiscal restraints that impede new capital investments. Therefore, an opportunity exists for the private sector to fund an information display system for displaying commercial advertisements while being flexible enough to display pertinent non-commercial information reflecting a current state of events. Methods for employing such systems with minimal or no cost to local municipalities or other government would be received very favorably.

### SUMMARY OF THE INVENTION

The invention relates to a variable signing system for displaying commercial advertising and pertinent non-commercial information. The invention also relates to methods for establishing such a system and for controlling the system. The variable signing system brings together the private and public sectors to provide a significant benefit to the citizens of a local geographical area. By adopting the variable signing system and program, a municipality will have the opportunity for an electronic display installed at little or no public expense for transmitting emergency messages to travelers on roads within their jurisdiction in exchange for approving a site for outdoor commercial advertising. The feed for the electronic display will connect directly to at least one government agency, such as a town's police station, a municipal building, emergency management services, Homeland Security Administration or the like thereby allowing message transmission to be controlled by government officials. All ongoing maintenance and repairs to the display preferably will be funded by the entity establishing the variable signing system. Ongoing transmission costs of broadcasting electric messages also may be funded by the private entity.

In one aspect of the present invention, the signing system includes a first display for displaying commercial information and a second display for displaying non-commercial information. The first display may be a static display, such as a conventional billboard. At least the second display is a dynamic display. The first and second displays may be on the same sign structure or on structures that are spaced from one another. In certain embodiments, the first and second displays both are dynamic displays. In this latter embodiment, the first and second dynamic displays may be two separate sign structures, two separate dynamic display panels on the same sign structure or a sharing of display time on a single dynamic display panel. The time sharing may be pursuant to certain predefined emergency conditions (e.g. Amber alert) and/or a negotiated agreement (e.g. 5% of the time for public service announcements). The dynamic display is any display known in the art that can be easily altered or is capable of showing moving images such as video. The dynamic-type display may be a plasma display, a liquid crystal display (LCD), a matrix LED panel, a liquid crystal light valve projector, etc.

According to a further aspect of the invention, a variable signing system includes a variable sign with a first display for displaying commercial information, a second display for displaying non-commercial information and at least one server for providing at least the non-commercial information to the variable sign. The variable signing system will further include at least one receiver for receiving at least the non-commercial information from a remote location and at least one processor for decoding the received information and sending the received information to at least the second display. The at least one server includes a transmitter for transmitting at least non-commercial information to the receiver of the variable sign. The at least one server may be coupled to a plurality of servers via a network for receiving the non-commercial information from a plurality of sources.

According to another aspect of the invention, a method for establishing and controlling a variable signing program is provided. The method includes the steps of conducting an assessment of geographic areas to determine the need for and feasibility of the signing system; analyzing local government laws and regulations pertaining to signing; developing a system proposal for appropriate government agencies; selecting a desired location for the display of commercial information, submitting a specific proposal to the responsible authority; receiving an approval for the desired location and establishing the approved variable signing system at the selected location. The method further includes receiving the commercial information and providing the commercial information to the first display either manually or electronically, e.g., by hardwired transmission or wirelessly. Upon detection of an abnormal condition, the responsible authority (e.g. a municipality, county, state or federal) will transmit non-commercial information to the second display. The non- commercial information may include an Amber Alert message, a traffic warning, a public service message, etc.

### BRIEF DESCRIPTION OF THE DRAWINGS

The above and other aspects, features and advantages of the present disclosure will become more apparent in light of the following detailed description when taken in conjunction with the accompanying drawings in which:

FIG. 1 is a perspective view of a variable sign according to an embodiment of the variable sign;

FIG. 2 is an overall system diagram to depict operations of the variable signing system of the invention; and

FIG. 3 is a flowchart illustrating a method for establishing and controlling a variable signing program according to an embodiment of the invention.

### DETAILED DESCRIPTION OF PREFERRED EMBODIMENTS

Preferred embodiments of the present invention will be described hereinbelow with reference to the accompanying drawings. In the following description, well-known functions or constructions are not described in detail to avoid obscuring the disclosure in unnecessary detail. Throughout the figures, like reference numerals represent like elements.

The variable signing program is a public/private initiative, where the income generated from a private enterprise provides the funding necessary to develop and install the variable signing system at no cost or minor cost to a county, municipality or other government entity. In turn, the government entity must grant approval for the installation of an outdoor advertising structure and the variable sign. Depending on a governments specific ordinance(s) or regulations governing outdoor advertising, permission may require a land use or zoning variance and/or site plan approval.

The variable signing program of the present invention advances the purposes of an “inherently beneficial use” under various State municipal land use laws. “Inherently beneficial uses” have generally been associated with enterprises recognized as providing substantial community value, so much so that municipalities are favorably disposed toward inclusion in their communities. Although these enterprises are generally non-commercial and institutional in nature (e.g., hospitals, sewage treatment plants, etc.), there has been a judicial tendency to expand the concept of “inherently beneficial use” to include certain commercial uses, depending upon site suitability and other factors. According to the variable signing program of the present invention, it is the commercial outdoor advertising display that supports the public (emergency) message display to promote the “inherently beneficial” land use.

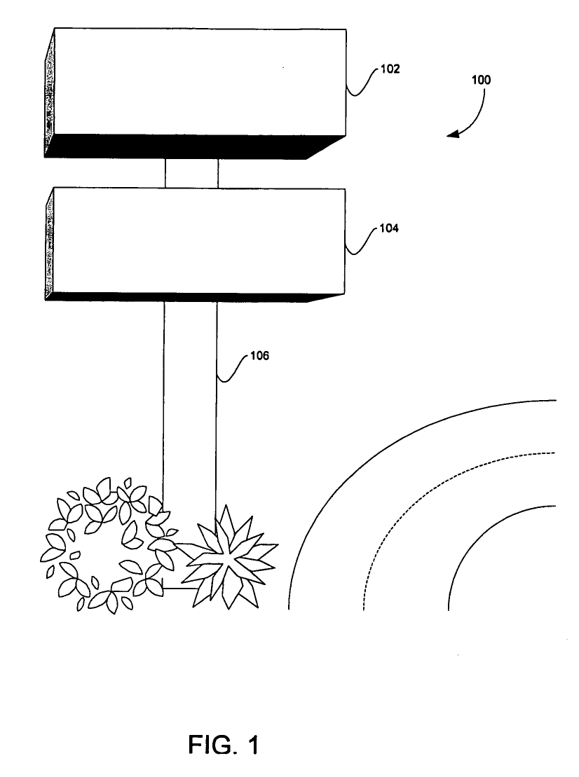

Referring to FIG. 1, a variable sign 100 for displaying commercial advertising and pertinent non-commercial information is illustrated schematically. The variable sign 100 includes a first display 102 for displaying commercial information and a second display 104 for displaying non-commercial information. In this illustrated embodiment, the first and second displays 102, 104 may be supported by any known structure 106, for example, a single column as shown or a double column. As noted above, however, the first and second displays 102, 104 may be on separate supports that are near one another or spaced from one another. The relative disposition of the displays may depend upon an assessment of needs of a particular geographic area or government agency requirements.

The first display 102 may be a static display such as a billboard, which includes a single image fixed to the display. At least the second display 104 is a dynamic display, and in some embodiments both the first and second displays 102, 104 are dynamic displays. A dynamic display is any display known in the art that can be altered easily to show a plurality of images or is capable of showing moving images, such as video. The dynamic display may be a plasma display, a liquid crystal display (LCD), a matrix LED panel, a liquid crystal light valve projector, etc. Embodiments where both the first and second displays 102 and 104 are dynamic displays can take several forms. For example, there can be two separate display panels, as shown in FIG. 1. Alternatively, a single panel may display commercial information at certain times and non-commercial information at other times. The non-commercial information may be displayed during emergencies or at times negotiated with the government agency.

Generally, the first display 102 will either display or broadcast commercial information supplied by a commercial entity and then placed on the first display 102 by a private administrator. In one embodiment, the second display 104 will remain blank, e.g., show no images, until a time when a responsible government authority determines pertinent non-commercial information needs to be broadcast.

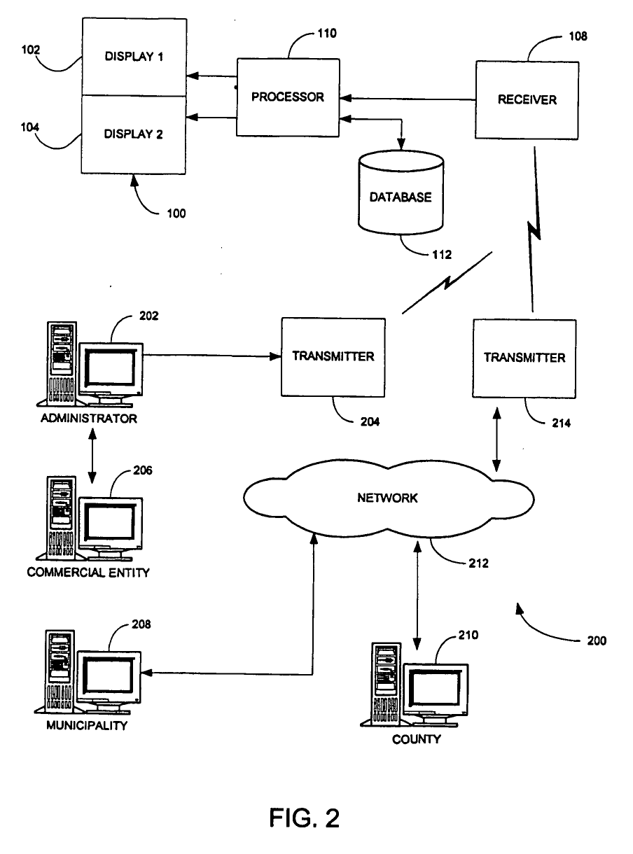

A variable signing system 200 including the variable sign 100 is illustrated in FIG. 2, in which the variable sign 100 is shown in more detail.

The variable signing system 200 includes the variable sign 100 including the first display 102 for displaying commercial information and the second display 104 for displaying non-commercial information. The variable signing system 200 will further include at least one receiver 108 for receiving the commercial and/or non-commercial information from at least one remote location and a processor 110 for decoding the received information and sending the received information to the first and second displays 102, 104. Optionally, the variable signing system 200 will include a database 112 of predefined messages that can be uploaded to either the first or second display 102, 104 upon a message received by the receiver 108. The use of predefined messages will speed up the loading time of each of the displays 102,104 and reduce the transmission time from the remote location.

The variable signing system 200 further includes at least one server 202, 208 for providing the commercial and non-commercial information to the variable sign 100. The at least one server 202, 208, 210 includes at least one transmitter 204, 214 for transmitting commercial and non-commercial information respectively to the receiver 108 of the variable sign 100. The information may be transmitted via landline, cellular phone, satellite relay or other wireless communication links. Depending on the transmission medium, the receiver 108 and transmitter 204 will be configured to match the transmission medium, for example, if the transmission medium is landline, the receiver 108 and transmitter 204, 214 may be analog or digital modems. As a further example, if the transmission medium is via a satellite relay, the receiver 108 and transmitter 204, 214 may include an antenna and modulator or demodulator as required. Alternatively, the variable display may include a network interface card (NIC) (not shown) for coupling the display to a network and for receiving the information via any known network transmission protocol, e.g., TCP/IP.

Preferably, the at least one server 202 is a system administrator that controls the commercial information being transmitted to the variable sign 100. The system administrator 202, may receive the commercial information from a plurality of sources. For example, the commercial information may be generated from a commercial entity 206, such as an advertising entity desiring to advertise a client's products and/or services. The administrator 202 generally will not prepare advertising copy, but may check advertising copy for accuracy. The non-commercial information may be diverse, and may be generated from different sources. For example, a municipality 208 may generate public service announcements or traffic alerts. Additionally, police or other responsible authorities may issue an Amber Alert, while federal agencies may issue a terror alert. The plurality of government sources 208, 210 are coupled via network 212, e.g., a Local Area Network (LAN), a Wide Area Network (WAN), the Internet or any other known network for coupling a plurality of servers.

The government agencies or municipalities could have the ability to send emergency messages directly to the variable sign 100 that would supersede the non-commercial information or scheduled community service messages. Emergency messages could be routed through a single government source, such as the local police department. Thus, the State Police or the Office of Homeland Security could have a link to the local Police Chief who in turn could send messages to the second display 104 or to the first display 102 in certain emergencies or where time is shared on a single dynamic display panel. Alternatively, the State Police or Office of Homeland Security could have the ability to send messages directly to the second display 104 or to override the first display in certain emergencies.

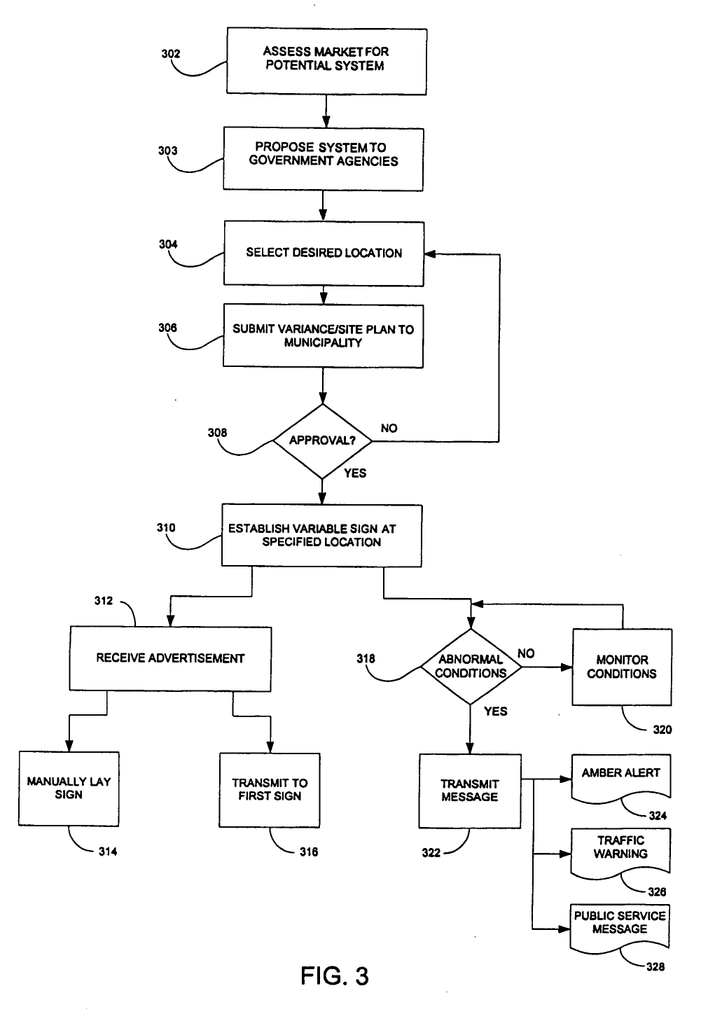

Referring to FIG. 3, a method or program for establishing and controlling the variable signing system will be described.

In step 302, the system administrator 202 will assess the market potential for the variable signing system 200 in a particular geographic area. The assessment may be based on urban area size, population density and various socio-economic or demographic data. The system administrator 202 then will propose the system concept to appropriate government agencies. The administrator 202 will select at least one preferred location if the concept is approved (step 304). This site selection will be based on socioeconomic and demographic data, but at a more local level. Traffic flow characteristics also will be considered. Based upon the location selected, the system administrator 202 will submit a site plan and/or land use variance to the appropriate government agencies 208 relating to the desired location of the variable sign 100 (step 306). The exact procedure here will vary widely from state to state and from one location to another. Once the location is approved by the government agency 208 (step 308), the variable signing system 200, including first and second displays of the variable sign 100 as described above will be established at the specific location(s) (step 310). Otherwise, if not approved, a new location will be selected for approval.

The first display 102 of the variable sign 100 may be disposed in one location, but the second display 104 or several second displays 104 may be disposed in another location. For example, the first display 102 may be a conventional billboard facing a road traveled by commuters, whereas the second display 104 or several second displays 104 could be positioned to face local feeder roads that would be used more by the local community. The positioning of the displays 102, 104 of the variable sign 100 would be based upon an assessment of the target for the different types of messages and based on input from the affected government agencies.

Furthermore, the second display 104 may have road safety or security features, such as a radar speed display sign, which displays the speed of cars approaching the sign. This aspect of the second display 104 offers another safety communication device which is an effective traffic calming device. The second display 104 can be installed permanently at a strategic roadside location or be portable and moved from place to place depending on the need of the municipality. Based on the premise that slower traffic is safer traffic, this is ideal for work zones, school zones and residential areas and protects pedestrians, children and workers. The radar speed aspect of the second display 104 may also include a transmitter for providing the police department with valuable traffic data including traffic counts and speed patterns to help maximize enforcement effectiveness.

As illustrated in FIG. 2, the system administrator 202 and the commercial entity 206 communicate, but are not coupled to the governments 208, 21O on their network 210. This, assures better control of the timeliness and accuracy of public data that is being displayed.

Once the variable signing system 200 is established, the system administrator 202 will receive an advertisement from the commercial entity 206 (step 312). The advertisement may be in the form of a printed display where large sheets representing the advertisement are manually laid at the location of a billboard (step 314). Alternatively, the system administrator 202 will receive the advertisement in electronic form including text, graphics, images and/or video and the system administrator 202 will transmit the advertisement to the first display 102 of the variable sign 100 (step 316).

Once the variable signing system 200 is functional, the second display 104of the variable sign 100 will continuously wait for an abnormal condition triggered by the municipality 208 (step 318). During this monitoring or waiting period (step 320), the second display 104 of the variable sign 100 may be blank and powered down to conserve power or may display general public service announcements.

When required, the municipality 208 may transmit a message to be displayed on the second display 104 (step 322). For example, the municipality 208 may transmit an Amber Alert message (step 324), a traffic advisory (step 326), a public service message (step 328) or any other message relevant to the community at large, e.g., environmental conditions.

It is to be understood that the present invention may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine comprising any suitable architecture such as servers 202, 206, 208 as shown in FIG. 2. Preferably, the machine is implemented on a computer platform having hardware such as one or more central processing units (CPU), a random access memory (RAM), a read only memory (ROM) and input/output (I/O) interface(s) such as keyboard, cursor control device (e.g., a mouse) and display device. The various hardware components are coupled together via a bus or other communication means for communicating information. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

In another embodiment, the variable signing system 200 will include a variable sign 100 with single entirely electronic variable display 102 or 104, such as those described above. The single variable display would be able to display various paid advertisements. However, a certain percentage of the time, e.g., 5%, would be allocated to community service messages that preferably would be routed through the system administrator 202. The percentage of the time allocated to community service messages would be subject to the agreement between the system administrator 202 and the community. The various timeslots for the advertising versus service messages may be based upon a market analysis, for example, community service messages might not be displayed during rush hour, but would be displayed more frequently when parents are dropping children off at school or picking them up. This scenario also would have the emergency override for Amber alerts, terrorist alerts and the like.

As an alternative to the above embodiment, the variable sign 100 may have a single variable display 102 or 104 incorporated into a school, park or municipal complex marquee. The variable sign will be used to communicate daily events, school sporting news and local messages and, on a moments notice, will instantly transmit emergency notifications to the local traveling public.

A variable signing system 200 and method for displaying commercial and non-commercial information have been described. Embodiments of the present disclosure provide local law enforcement officials with a number of significant benefits, including being able to participate and coordinate with State Amber Alert initiatives, announce emergency traffic situations such as accidents, re-direct traffic in the event of road closures, etc. Additionally, the system and method of the present disclosure provide a number of additional benefits to local municipalities, including the ability to broadcast Homeland Security announcements; the ability to communicate local traffic problems, such as congestion, detours, etc.; the ability to announce other local emergency messages, such as floods, fires, etc.; the ability to relay public service messages; the ability to announce community events; the opportunity to be viewed as a progressive municipality serving the needs of its citizens; and the opportunity to be recognized by the State as supporting the Amber Alert initiative, without asking for state budget dollars.

While the disclosure has been shown and described with reference to certain preferred embodiments thereof, it will be understood by those skilled in the art that various changes in form and detailed may be made therein without departing from the spirit and scope of the disclosure as defined by the appended claims.

What is claimed is:

1. A variable sign comprising:
a first display for displaying commercial information; and
a second display for dynamically displaying non-commercial information.

2. The variable sign of claim 1, wherein both the first and second displays are dynamic displays, further comprising a processor for generating the commercial and non-commercial information to be displayed.

3. The variable sign of claim 2, wherein the first and second displays are presented on a single display panel, and wherein the processor includes a switch for displaying only one of the commercial or non-commercial information at any given time.

4. The variable sign of claim 1, wherein at least the second display is a plasma display, a liquid crystal display (LCD), a matrix LED panel, or a liquid crystal light valve projector.

5. The variable sign of claim 1, wherein the second display is located remotely from the first display.

6. A variable signing system comprising:
a variable sign including a first display for displaying commercial information and a second display for dynamically displaying non-commercial information; and
at least one server for providing at least the non-commercial information to at least the second display.

7. The variable signing system of claim 6, further comprising a receiver for receiving at least the non-commercial information to be displayed by the second display via hardwired transmission or wirelessly.

8. The variable signing system of claim 7, further comprising a database including a plurality of predefined messages, wherein at least one of the predefined messages is displayed on the second display upon receipt of data.

9. The variable signing system of claim 6, wherein both the first and second displays are dynamic displays and wherein the variable signing system further includes a receiver for receiving the commercial and non-commercial information from the at least one server and a processor for decoding the received information and sending the received information to the first and second displays.

10. The variable signing system of claim 9, wherein the at least one server includes a transmitter for transmitting the commercial and non-commercial information to the receiver.

11. The variable signing system of claim 9, further comprising a database including a plurality of predefined messages, wherein at least one of the predefined messages is displayed on the first or second display upon receipt of the commercial or non-commercial data.

12. The variable signing system of claim 9, wherein the second display is located remotely from the first display.

13. The variable signing system of claim 9, further comprising a transmitter for transmitting data collected at a site of the second display to the at least one server.

14. The variable signing system of claim 6, wherein the at least one server is coupled to a plurality of servers via a network for receiving the non-commercial information from a plurality of sources.

15. The variable signing system of claim 14, wherein at least one of the plurality of sources is a municipality and the non-commercial information is an Amber Alert message, a traffic warning, or a public service message.

16. A method for establishing a variable signing system for displaying information, the variable signing system including at least one variable sign including a first display for displaying commercial information and a second display for displaying non-commercial information, at least the second display being a dynamic display, the method comprising the steps of:
selecting a geographic area for the variable signing system based on analysis of data for the geographic area;
submitting to a responsible authority an application for approval of the variable signing system;
receiving approval for the variable signing system first and second displays;
selecting at least one specific location in the geographic area for the variable sign of the variable signing system;
submitting a specific proposal for the variable sign to a second responsible authority;
receiving approval for the variable sign; and
installing both the first and second displays of the variable sign at the at least one specific location.

17. The method as in claim 16, wherein the first display is a dynamic display, and the method further comprising the steps of:
receiving the commercial information for the first display at a location remote from the desired location; and
transmitting the commercial information electronically to the first display.

18. The method as in claim 17, wherein the transmitting step is performed by hardwired transmission or wirelessly.

19. The method as in claim 16, further comprising receiving non-commercial information indicative of an abnormal condition, and transmitting non-commercial information indicative of the abnormal condition to the second display.

20. The method of claim 16, wherein the first display is a dynamic display and wherein the first and second displays are displayed on a single variable sign, the method further comprising allocating times for displaying the commercial information as the first display and the non-commercial information as the second display on the single variable sign.

21. The method of claim 20, further comprising receiving information indicative of an abnormal condition and interrupting the display of either one of the commercial and non-commercial information to display information indicative of the abnormal condition.
